(19) United States
(12) Patent Application Publication
(10) Pub. No.: US 2010/0180920 A1
(43) Pub. Date: Jul. 22, 2010

(54) AGENT SUPPLY DEVICE

(75) Inventors: Shinji Fujimoto, Neyagawa (JP); Takeshi Shiba, Hikone (JP); Juzaemon Iwasaki, Nagahama (JP); Masaaki Sato, Hikone (JP); Masanobu Yamasaki, Hikone (JP); Shunsuke Komori, Hikone (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC WORKS, LTD., Osaka (JP)

(21) Appl. No.: 12/067,215

(22) PCT Filed: Sep. 27, 2006
(86) PCT No.: PCT/JP2006/319118

§ 371 Date: Mar. 18, 2008

(30) Foreign Application Priority Data
Sep. 27, 2005 (JP) P2005-280967

(51) Int. Cl. B08B 3/00

(52) U.S. Cl. 134/184

(57) ABSTRACT

In a agent supply device, a agent supplying unit is driven to supply a treatment agent to a head portion provided on a hair processing device after a cleaning unit cleans the head portion.

### BACKGROUND OF THE INVENTION

1. Field of the Invention

The present invention relates to a agent supply device that supplies a treatment agent to a hair processing device that shaves and pulls out hair as hair removing processing.

2. Description of the Related Art

Conventionally, there has been proposed a agent supply device that supplies a treatment agent such as shaving lotion to a head portion that carries out hair removing processing of a hair processing device such as an electric shaver and a hair removing device (for example, Japanese Patent Application Laid-open No. 2003-339425). With this technique, the treatment agent is applied to a skin surface from the head portion during the hair removing processing, and a slipping degree of the skin surface is enhanced.

Some of hair processing devices have a agent supply unit that supplies a treatment agent to the skin surface during the hair removing processing.

However, if the treatment agent is supplied to the skin surface and the hair removing processing is carried out by the hair processing device, dust such as remaining treatment agent and flocking adheres to the head portion that carries out the hair removing processing and the head portion becomes dirty. There is a problem that a new treatment agent is supplied to the head portion when the next hair removing processing is carried out, and dust such as flocking remaining on the head portion is mixed with the new treatment agent and these adhere to a user's skin surface and this offends the user.

### SUMMARY OF THE INVENTION

An object of the present invention is to suppress a case that dust such as flocking remaining on a head portion of a hair processing device adheres to a user's skin surface during hair removing processing, and making the user feel uncomfortable.

A agent supply device according to the present invention includes a cleaning unit that cleans a head portion provided on a hair processing device that removes hair, a agent supplying unit that supplies a treatment agent used when removing hair to the head portion, and a control unit that drives the agent supplying unit after a cleaning operation of the head portion by the cleaning unit is completed.

According to this configuration, the agent supplying unit is driven after the cleaning operation of the head portion by the cleaning unit is completed. Therefore, the treatment agent is supplied to the clean head portion from which dust such as remaining flocking is removed, dust remaining on the head portion does not adhere to a skin surface during the hair removing processing, and it is possible to avoid a case that dust such as flocking remaining on the head portion adheres to a skin surface so that a user feels uncomfortable.

According to the present invention, it is preferable that the cleaning unit cleans the head portion using cleaning liquid, the treatment agent is powdery, and the control unit allows the agent supplying unit to supply the treatment agent to the head portion in a state where the head portion is cleaned by the cleaning unit and the cleaning liquid adheres to the head portion.

According to this configuration, because the powdery treatment agent is supplied to the head portion to which the cleaning liquid adheres, the powdery treatment agent can reliably adhere to the head portion by the cleaning liquid. With this, high skin slip effect by the powdery treatment agent can be obtained.

According to the present invention, it is preferable that the treatment agent is powdery, and the agent supplying unit discharges the treatment agent together with liquid and supplies them to the head portion.

According to this configuration, the powdery treatment agent is discharged out together with liquid and they are supplied to the head portion. Therefore, the powdery treatment agent can reliably adhere to the head portion by the liquid. With this, high skin slip effect by the powdery treatment agent can be obtained.

According to the present invention, it is preferable that the agent supply device comprises a supporting unit that moves the head portion selectively to a cleaning position where the head portion is cleaned by the cleaning unit and a supply position where the treatment agent is supplied by the agent supplying unit, wherein the control unit drives the supporting unit such that the head portion is located at the cleaning position when the head portion is cleaned by the cleaning unit, and the head portion is located at the supply position when the treatment agent is supplied by the agent supplying unit.

According to this configuration, the head portion is at the cleaning position when the cleaning unit cleans, and the head portion is at the supply position when the agent supplying unit supplies the treatment agent. Therefore, it is possible to prevent the cleaning liquid and the treatment agent from being mixed and thus, it is possible to prevent functions of the cleaning liquid and the treatment agent from being deteriorated.

According to the present invention, it is preferable that the agent supply device comprises a drying unit that dries the head portion, wherein the control unit drives the drying unit after the agent supplying unit supplies the treatment agent to the head portion.

According to this configuration, the head portion after the treatment agent is supplied is dried by the drying unit. Thus, even if the head portion comes into contact with a skin surface, a user does not feel wet or cold by the cleaning liquid or liquid. Thus, a user who does not like to feel wet or cold does not have an uncomfortable feeling.

According to the present invention, it is preferable that the cleaning unit includes a filter unit that filters the cleaning liquid, the agent supplying unit includes a agent container in which the treatment agent is stored, the filter unit and the agent container are integrally formed together to constitute a cartridge, and the agent supply device further comprises a cartridge supporting unit that detachably supports the cartridge.

According to this configuration, the filter unit and the agent container constitute the cartridge and thus, the filter unit and the agent container can be exchanged by one exchanging operation and thus, the labor of the exchanging operation can be reduced.

According to the present invention, it is preferable that the agent supply device comprises a cleaning unit that cleans a head portion of a hair processing device including the head portion that removes hair and a skin surface agent supplying unit that supplies a treatment agent used when removing hair to a skin surface, a agent supplying unit that supplies the treatment agent to the skin surface agent supplying unit, and a control unit that drives the cleaning unit and the agent supplying unit with one set.

According to this configuration, the driving operation of the cleaning unit and the driving operation of the agent supplying unit are carried out with one set. Thus, if these driving operations are completed, dust is removed from the head portion of the hair processing device and the head portion is cleaned, and the treatment agent is supplied to the skin surface agent supplying unit. Therefore, when the hair processing device is used, a treatment agent can be supplied to the clean head portion from the skin surface agent supplying unit and the hair removing processing can be carried out. Thus, it is possible to avoid a case that dust such as flocking remaining on the head portion adheres to a skin surface so that a user feels uncomfortable.

According to the present invention, it is preferable that the hair processing device includes a agent collecting unit that collects the treatment agent on a skin surface and the cleaning unit cleans the agent collecting unit.

According to this configuration, the cleaning unit cleans the agent collecting unit of the hair processing device. With this, the agent collecting unit can be cleaned.

According to the present invention, it is preferable that the agent supply device comprises a supporting unit that supports the hair processing device such that the head portion becomes a lower end of the hair processing device when the agent supplying unit supplies the treatment agent.

According to this configuration, a treatment agent is supplied by the agent supplying unit in a state where the head portion is located at the lower end of the hair processing device. Therefore, it is possible to prevent the treatment agent from running into a portion of the hair processing device other than the head portion, and it is possible to avoid a case that a treatment agent adheres to a user's hand that grasps the other portion (grip) of the hair processing device other than the head portion and the user feels uncomfortable.

According to the present invention, it is preferable that the agent supply device comprises a cleaning unit that cleans a head portion provided on a hair processing device that removes hair, and a agent supplying unit that can supply a treatment agent used when removing hair to the head portion after a cleaning operation of the head portion by the cleaning unit is completed.

According to this configuration, a treatment agent can be supplied to the head portion after the cleaning operation of the head portion by the cleaning unit is completed. Thus, the treatment agent can be supplied to the cleaned head portion from which dust such as remaining flocking is removed. Therefore, dust remaining on the head portion does not adhere to a skin surface during the hair removing processing, and it is possible to avoid a case that dust such as flocking remaining on the head portion adheres to a skin surface so that a user feels uncomfortable.

### BRIEF DESCRIPTION OF THE DRAWINGS

FIG. 1 is a perspective view of a agent supply device and a hair processing device according to a first embodiment of the present invention;

FIG. 2 is a front view of the hair processing device;

FIG. 3 is a bottom view of the hair processing device;

FIG. 4 is a vertical sectional view of the agent supply device;

FIG. 5 is a vertical sectional view of the agent supply device in a state where the hair processing device is supported;

FIG. 6 is a side sectional view of the agent supply device at the time of cleaning operation;

FIG. 7 is a vertical sectional view of the agent supply device when a treatment agent is supplied;

FIG. 8 is a perspective sectional view of a cartridge;

FIG. 9 show a supporting unit of the agent supply device, where FIG. 9(a) is a front view and FIG. 9(b) is a side view;

FIG. 10 is a block diagram showing an electric system of the agent supply device;

FIG. 11 is a flowchart of agent supply processing of the agent supply device;

FIG. 12 is a vertical sectional view of a agent supply device and a hair processing device according to a second embodiment of the present invention;

FIG. 13 is a vertical sectional view of a agent supply device and a hair processing device according to a third embodiment of the present invention; and

FIG. 14 is a vertical sectional view of a agent supply device and a hair processing device according to a fourth embodiment of the present invention.

### DETAILED DESCRIPTION OF THE PREFERRED EMBODIMENTS

### First Embodiment

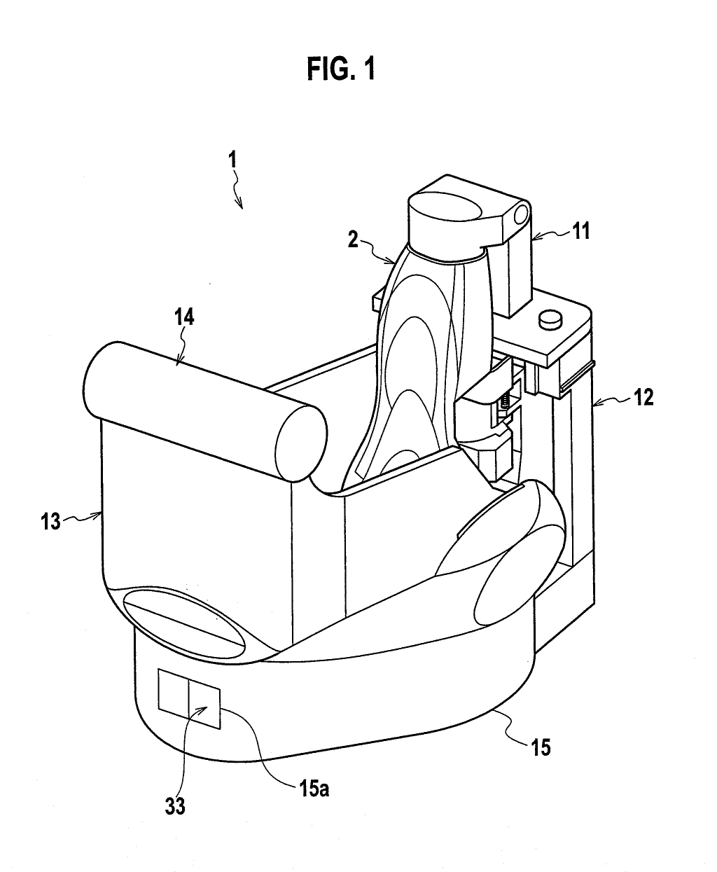

A first embodiment of the present invention will be explained below with reference to FIG. 1 to FIG. 11.

FIG. 1 is a perspective view of a agent supply device 1 and a hair processing device 2 according to the first embodiment. As shown in FIG. 1, the agent supply device 1 supports the hair processing device 2, cleans a head portion 3 of the hair processing device 2, and supplies a treatment agent A. The agent supply device 1 and the hair processing device 2 constitute a hair processing system.

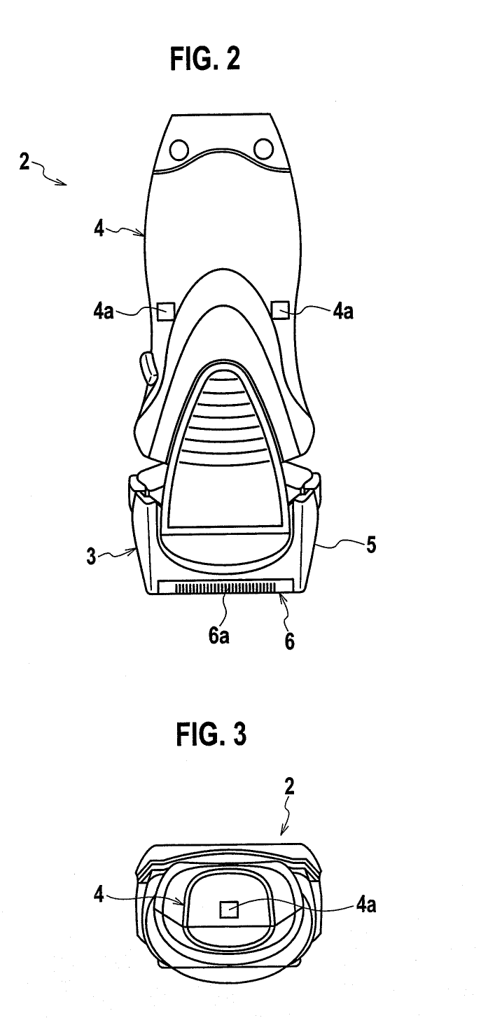

The hair processing device 2 is explained below. FIG. 2 is a front view of the hair processing device 2. FIG. 3 is a bottom view of the hair processing device 2. As shown in FIGS. 2 and 3, the hair processing device 2 is an electric shaver including a grip 4 and the head portion 3 that removes hair by cutting the hair.

The head portion 3 includes a case 5 and a blade 6 provided on the case 5. The blade 6 includes an outer blade 6a that is a fixed blade, and an inner blade that is a movable blade disposed inside the outer blade 6a. The inner blade reciprocates, thereby cutting hair by the outer blade 6a and the inner blade.

A control unit and a rechargeable battery (not shown) are incorporated in the grip 4. The hair processing device 2 can be a hair removing device that removes hair instead of the electric shaver.

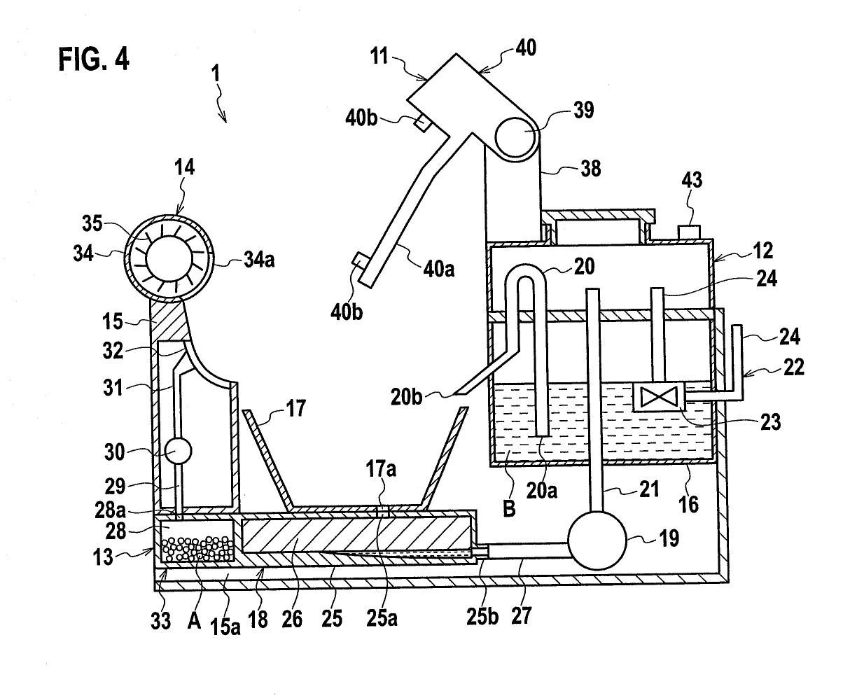

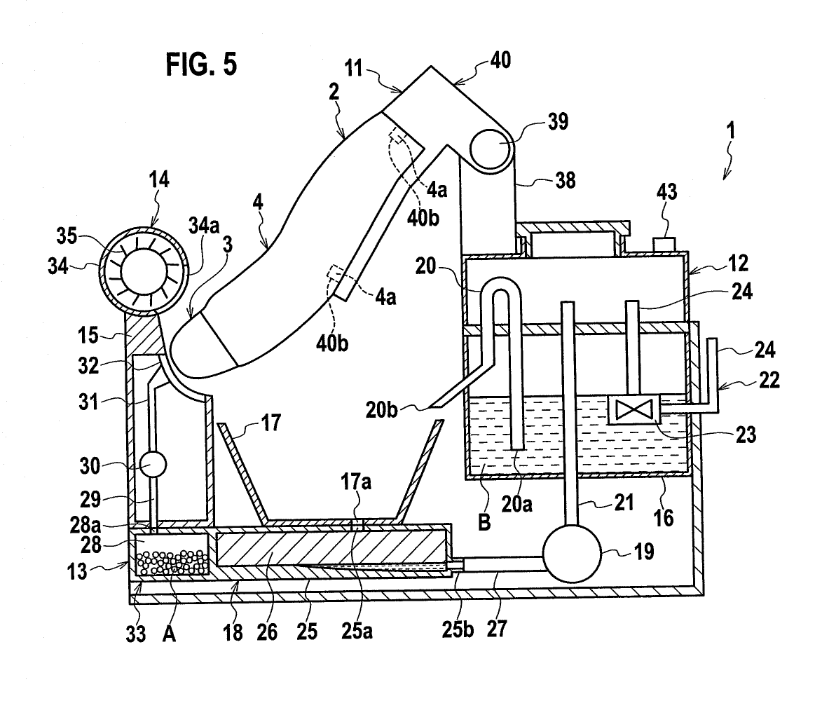

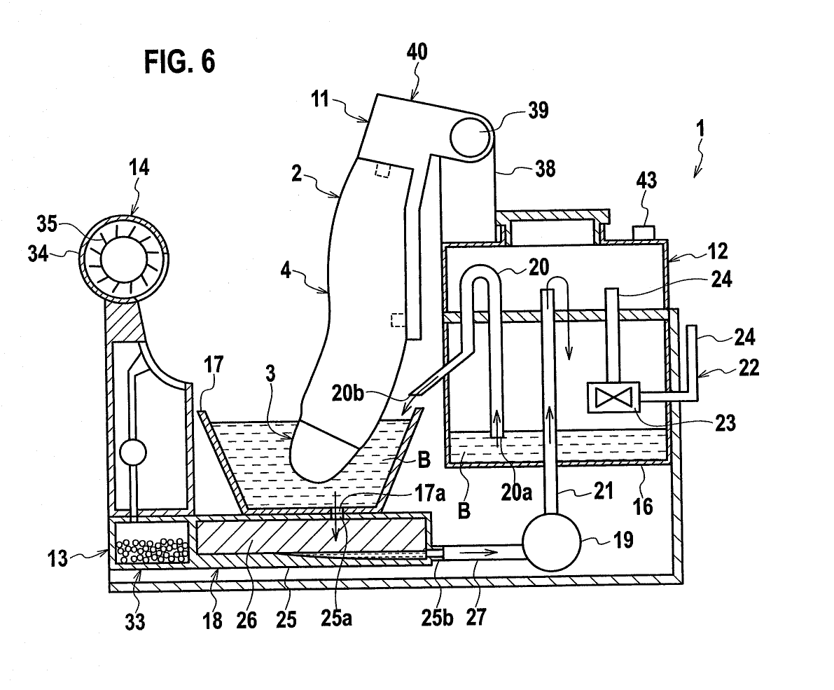

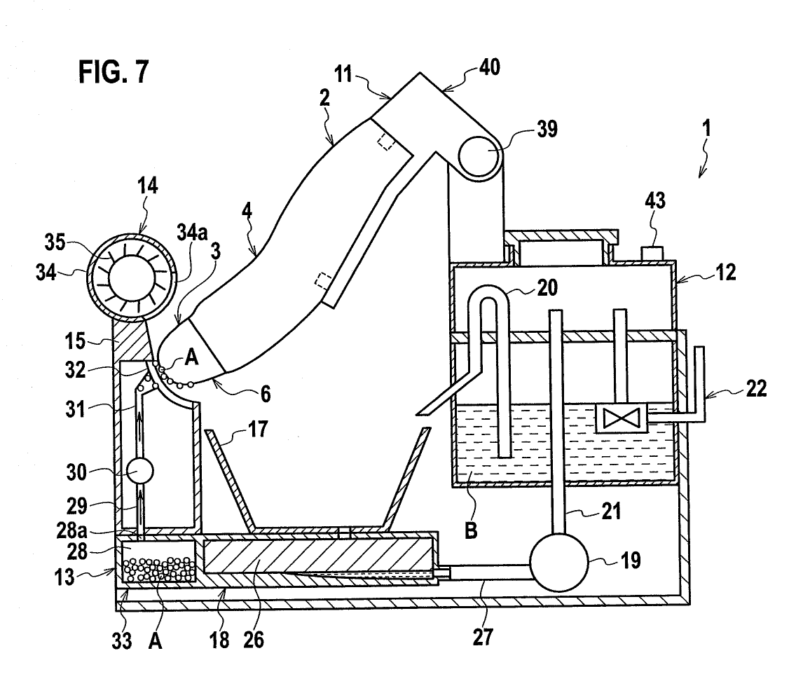

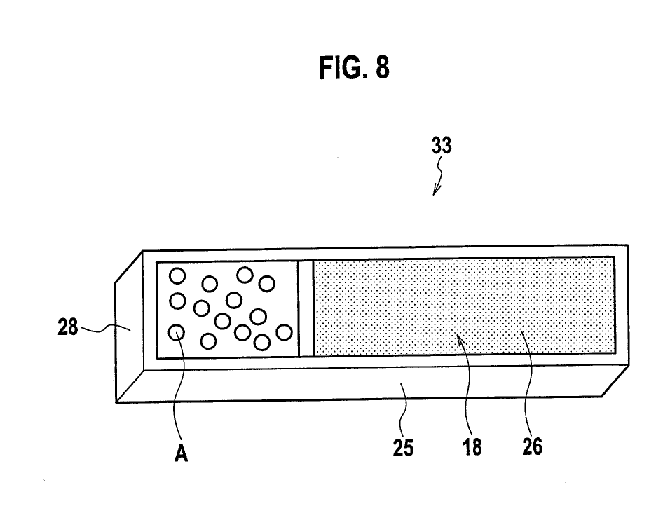

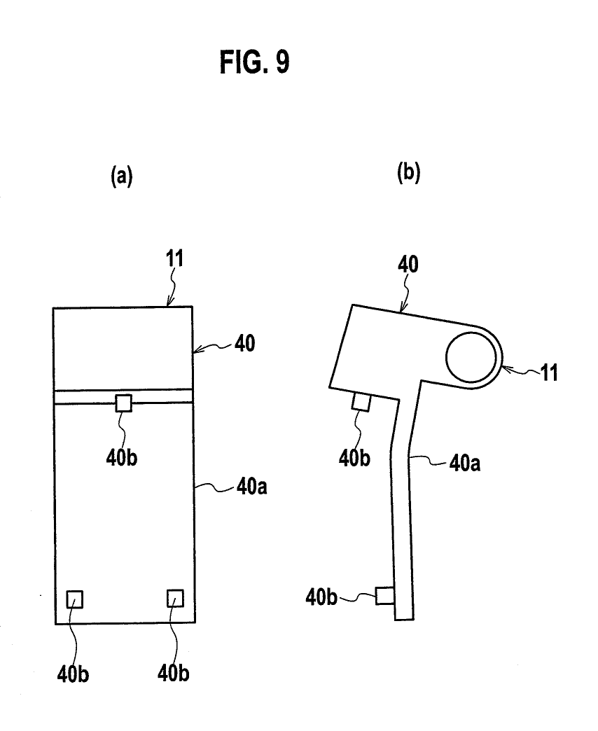

Next, various portions of the agent supply device 1 will be explained in detail. FIG. 4 is a vertical sectional view of the agent supply device 1. FIG. 5 is a vertical sectional view of the agent supply device 1 in a state where the hair processing device 2 is supported. FIG. 6 is a side sectional view of the agent supply device 1 at the time of cleaning operation. FIG. 7 is a vertical sectional view of the agent supply device 1 when a treatment agent is supplied. FIG. 8 is a perspective sectional view of a cartridge 33. FIG. 9 show a supporting unit 11 of the agent supply device 1, where FIG. 9(a) is a front view and FIG. 9(b) is a side view.

As shown in FIGS. 4 to 7, the agent supply device 1 includes a supporting unit 11 that detachably supports the hair processing device 2, a cleaning unit 12 that cleans the head portion 3 of the hair processing device 2 supported by the supporting unit 11, a agent supplying unit 13 that supplies a powdery treatment agent A to the cleaned head portion 3, and a drying unit 14 that dries the head portion 3 to which the treatment agent is supplied. The agent supply device 1 also includes a housing 15 in which the cleaning unit 12, the agent supplying unit 13 and the drying unit 14 are provided. The powdery treatment agent A is used for removing hair by the hair processing device 2, and enhances the slipping degree of a skin surface, for example.

The cleaning unit 12 includes a hermetical tank 16 in which cleaning liquid B is stored, a cleaning pan 17 in which the cleaning liquid B supplied from the tank 16 is temporarily stored, a filter unit 18 that filters the cleaning liquid B discharged from the cleaning pan 17, and a pump 19 that returns the cleaning liquid B discharged from the filter unit 18 into the tank 16 and that circulates the cleaning liquid B within the cleaning unit 12.

The tank 16 is provided with a discharge pipe 20 through which the cleaning liquid B stored in the tank 16 is discharged into the cleaning pan 17, a supply pipe 21 that supplies the cleaning liquid B into the tank 16, and a valve device 22 that adjusts an internal pressure in the tank 16.

A suction port 20a of the discharge pipe 20 is soaked in the cleaning liquid B in the tank 16. A delivery port 20b of the discharge pipe 20 is disposed outside the tank 16 so that the cleaning liquid B can be supplied to the cleaning pan 17.

The supply pipe 21 brings the discharge side of the pump 19 and the tank 16 into communication with each other.

The valve device 22 includes a solenoid valve 23 and a communication pipe 24 that brings inside and outside of the tank 16 into communication with each other through the solenoid valve 23.

An upper face of the cleaning pan 17 is opened. A discharge port 17a is formed in a bottom wall of the cleaning pan 17.

The filter unit 18 is continuously provided below a lower portion of the cleaning pan 17. The filter unit 18 has a filter case 25 having a filter 26. An upper wall of the filter case 25 is formed with an inflow port 25a which is in communication with the discharge port 17a of the cleaning pan 17. A discharge port 25b is formed in a sidewall of the filter case 25, and the discharge port 25b is connected to the pump 19 through a connecting pipe 27.

In the cleaning unit 12, the cleaning liquid B and air are supplied into the tank 16 in which the solenoid valve 23 is closed and the hermeticity is maintained. With this, the internal pressure in the tank 16 is increased, and the cleaning liquid B in the tank 16 is discharged into the cleaning pan 17 from the discharge pipe 20. When the cleaning liquid B or air is supplied into the tank 16 from the pump 19 in a state where the solenoid valve 23 is opened, air in the tank 16 is discharged outside the tank 16 from the communication pipe 24. In this case, the cleaning liquid B is not discharged from the discharge pipe 20. Thus, in such a case, the cleaning liquid B in the cleaning pan 17 is collected into the tank 16.

The agent supplying unit 13 includes a agent container 28 in which the treatment agent A is stored, a pump 30 having a suction side in communication with the agent container 28 through a pipe 29, and a agent delivery port 32 which is communicated with a discharge side of the pump 30 through a pipe 31. The agent container 28, the pump 30 and the delivery port 20b are disposed from below to above in this order.

The agent container 28 is provided its upper wall with a through hole 28a. The through hole 28a is connected to the pipe 29. The agent container 28 is integrally formed on the filter case 25 of the filter unit 18. With this, the agent container 28 and the filter unit 18 are integrated to constitute the cartridge 33 (FIG. 8). The cartridge 33 can be attached to and detached from the housing 15 from forward. That is, the housing 15 is provided with a cartridge supporting unit 15a that detachably supports the cartridge 33.

The agent delivery port 32 discharges a treatment agent to a rear and diagonally upward direction. As will be described later, the agent delivery port 32 is provided at a location opposed to the head portion 3 located at a supply position (set position) by the supporting unit 11.

Examples of the pump 30 are a gear pump, a diaphragm pump and a fan pump.

According to the agent supplying unit 13, if the pump 30 is operated, the powdery treatment agent stored in the agent supplying unit 13 is discharged from the agent delivery port 32 toward the head portion 3, and the treatment agent is supplied to the head portion 3.

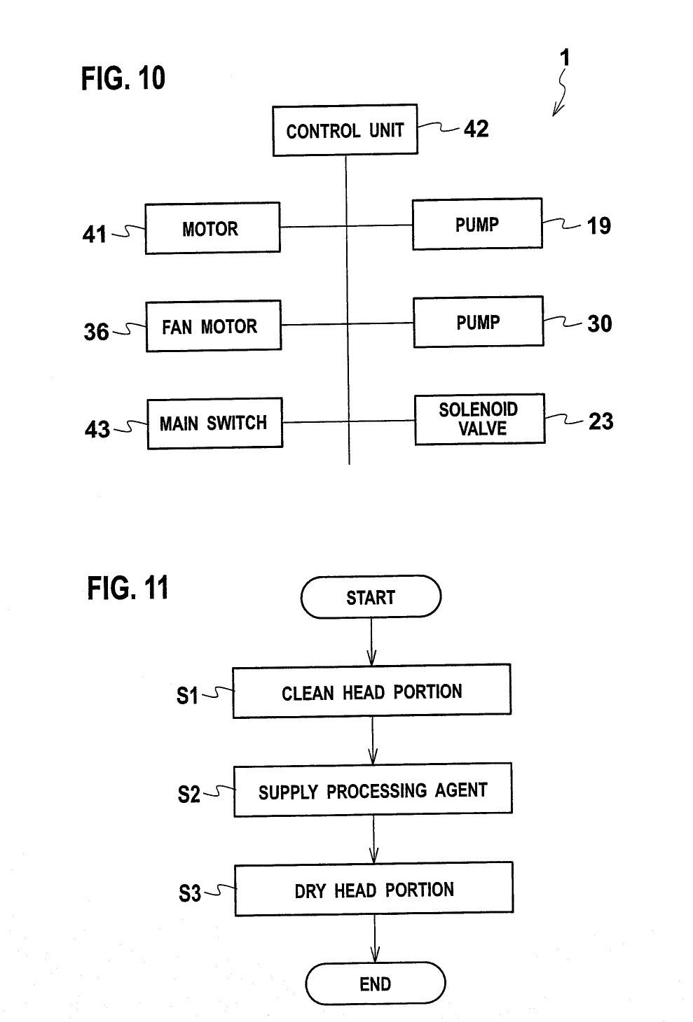

The drying unit 14 is disposed above the agent supplying unit 13. The drying unit 14 includes a fan case 34, a fan 35 accommodated in the fan case 34, a fan motor 36 (see FIG. 10) which is accommodated in the fan case 34 to rotate the fan 35, and a heat wire (not shown) accommodated in the fan case 34.

The fan case 34 is provided with a suction port (not shown) from which air is sucked, and an air blasting port 34a through which air blows. The air blasting port 34a opens into a rear and diagonally downward direction. The air blasting port 34a is provided at a location opposed to the head portion 3 located at the supply position by the supporting unit 11 as will be described later.

According to the drying unit 14, the fan 35 is rotated by the fan motor 36 in a state where the energized heat wire heats, air sucked from the suction port is heated and sent to the head portion 3 from the air blasting port 34a.

The supporting unit 11 includes a fixed portion 38 that stands on an upper face of the tank 16, and an arm portion 40 that is turnably provided on the fixed portion 38 through a shaft 39 and that detachably supports the hair processing device 2.

The arm portion 40 supports the hair processing device 2. The arm portion 40 is provided with a support wall 40a that is formed into a shape extending along a back face and a bottom face of the hair processing device 2 and supports the back face and the base face. As shown in FIG. 9, a fitting projection 40b stands on the support wall 40a. The fitting projection 40b is detachably fitted into two fitting recesses 4a (see FIG. 2) formed in the back face of the hair processing device 2 and one fitting recesses 4a (see FIG. 3) formed in the bottom face.

The arm portion 40 can selectively move and turn the head portion 3 of the supported hair processing device 2 to the supply position (FIG. 5) and the cleaning position (FIG. 6). The arm portion 40 is turned by a motor 41 (see FIG. 10). The supply position is a position where the head portion 3 is opposed to the agent delivery port 32 of the agent supplying unit 13 and the air blasting port 34a of the drying unit 14, and a treatment agent A is supplied by the agent supplying unit 13 and air sent by the drying unit 14 can be received. The supply position is also a set position where the hair processing device 2 is set to the agent supply device 1. The cleaning position is a position where the head portion 3 is located in the cleaning pan 17 of the cleaning unit 12. In the cleaning position, the head portion 3 can be cleaned by the cleaning unit 12. In the supply position and the cleaning position, the head portion 3 is a lower end of the hair processing device 2. That is, the outer face of the head portion 3 is directed downward.

The fitting recesses 4a provided in the bottom face of the hair processing device 2 and the fitting projection 40b of the supporting unit 11 corresponding to the fitting recesses 4a are respectively provided with connection terminals (not shown). The hair processing device 2 is fixed to the arm portion 40, the connection terminals are connected to each other, electricity is supplied to the hair processing device 2 from the agent supply device 1 connected to a commercial power supply and the hair processing device 2 is charged with electricity.

FIG. 10 is a block diagram showing the electric system of the agent supply device 1. As shown in FIG. 10, the agent supply device 1 includes a control unit 42 that drives and controls various portions. The control unit 42 includes an electronic circuit. The pumps 19, 30, the solenoid valve 23, the fan motor 36, the motor 41, a main switch 43 and a power supply circuit (not shown) are connected to the control unit 42. With this, the control unit 42 can drive and control the various portions of the agent supply device 1. The main switch 43 is disposed on the upper face of the tank 16 of the cleaning unit 12 (see FIG. 4).

Next, the processing carried out by the control unit 42 and operations of the various portions of the agent supply device 1 will be explained. FIG. 11 is a flowchart of the agent supply processing of the agent supply device 1.

As shown in FIG. 11, when the main switch 43 is turned ON, the head portion 3 is cleaned (step S1). More specifically, the motor 41 is driven, and the arm portion 40 that supports the hair processing device 2 is turned from the supply position to the cleaning position (FIG. 6). A function of a control unit that drives the supporting unit 11 such that the head portion 3 is located at the cleaning position when the head portion 3 is cleaned by the cleaning unit 12 is executed. Next, the pump 19 is driven, the cleaning liquid B in the tank 16 is supplied to the cleaning pan 17, and the head portion 3 is soaked in the cleaning liquid B. At that time, the cleaning liquid B is discharged into the filter case 25 from the discharge port 17a of the cleaning pan 17 little by little, and the cleaning liquid B is filtered by the filter 26. The filtered cleaning liquid B is again returned to the tank 16 by the pump 19. The same amount of cleaning liquid B as that of the cleaning liquid B returned to the tank 16 is supplied to the cleaning pan 17 from the discharge pipe 20 of the tank 16. At that time, the pump 19 is driven and controlled such that the cleaning liquid B does not overflow from the cleaning pan 17. The cleaning liquid B is circulated in the cleaning unit 12 by the pump 19. The state where the head portion 3 is soaked in the cleaning liquid B in the cleaning pan 17 is maintained for a prescribed time. With this, beard and sebum attached to the head portion 3 of the hair processing device 2 are removed from the head portion 3, and the head portion 3 is cleaned. At that time, the inner blade of the blade 6 of the hair processing device 2 is driven to vibrate the head portion 3 and with this, the cleaning effect can further be enhanced. At that time, because dust such as beard and serum in the cleaning liquid B is removed by the filter 26, the head portion 3 can be reliably cleaned by the clean cleaning liquid B.

Next, after such a cleaning operation is carried out, in a state where the pump 19 is driven, the solenoid valve 23 is opened, all of the cleaning liquid B in the cleaning pan 17 is returned to the tank 16, the cleaning pan 17 is made empty, the motor 41 is driven, and the arm portion 40 that supports the hair processing device 2 is turned to the cleaning position from the supply position (FIG. 5). A function of the control unit that drives the supporting unit 11 such that the head portion 3 is located at the supply position when the treatment agent A is supplied by the agent supplying unit 13 is executed.

Next, the treatment agent is supplied to the head portion 3 of the hair processing device 2 (step S2). Concretely, the pump 30 is driven, the treatment agent A stored in the agent container 28 is discharged toward the head portion 3 from the agent delivery port 3, and the treatment agent A is supplied to the head portion 3 (FIG. 7). At that time, the cleaning liquid B adheres to the head portion 3. That is, in the first embodiment, the treatment agent A is supplied to the wet head portion 3 to which the cleaning liquid B adheres. A function of the control unit that drives the agent supplying unit 13 after the cleaning operation of the head portion 3 by the cleaning unit 12 is completed, and a function of the control unit that supplies the treatment agent A to the head portion 3 to which the cleaning liquid adheres by the agent supplying unit 13 is executed. With this, the treatment agent A reliably adheres to the head portion 3 by the cleaning liquid B.

Next, the fan motor 36 of the drying unit 14 is driven, hot air from the air blasting port 34a blows on the head portion 3, excessive moisture (cleaning liquid B) on the head portion 3 is evaporated, and the head portion 3 is dried (step S3). With this, only the powdery treatment agent A strongly adheres to the head portion 3 and remains thereon. A function of the control unit that drives the drying unit 14 after the treatment agent A is supplied to the head portion 3 by the agent supplying unit 13 is executed.

During this processing, electricity is supplied from the connection terminal of the agent supply device 1 to the connection terminal of the hair processing device 2, and the hair processing device 2 is charged with electricity.

When the shaving motion is carried out by the hair processing device 2 to which the treatment agent A is supplied, a user detaches the hair processing device 2 from the supporting unit 11, brings the head portion 3 into contact with a skin surface to carry out the shaving motion. Because the treatment agent A which adheres to the head portion 3 is supplied to the skin surface by this shaving motion, it is possible to shave while applying the powdery treatment agent A to the skin surface, the skin slip effect, and skin-disorder suppressing effect are exhibited, and a comfortable shaving feeling can be achieved.

As explained above, according to the first embodiment, the agent supplying unit 13 is driven after the cleaning operation of the head portion 3 by the cleaning unit 12 is completed. Therefore, the treatment agent A is supplied to the head portion 3 in a state where dust such as remaining flocking is removed, and dust such as flocking remaining on the head portion 3 does not adheres to a skin surface. Thus, in the hair removing processing, dust such as flocking remaining on the head portion 3 does not adheres to a skin surface, so that the user does not feel uncomfortable.

According to the first embodiment, because the powdery treatment agent A is supplied to the head portion 3 to which the cleaning liquid B adheres, the powdery treatment agent A can reliably adhere to the head portion 3 by the cleaning liquid B. With this, high skin slip effect by the powdery treatment agent A can be obtained, and it is possible to reliably avoid a case that the treatment agent A overflows from the head portion 3 or the treatment agent A hits the head portion 3 and scatters.

According to the first embodiment, the head portion 3 is located at the cleaning position when the head portion 3 is cleaned by the cleaning unit 12, and the head portion 3 is located at the supply position when the agent supplying unit 13 supplies the treatment agent A. Therefore, it is possible to prevent the cleaning liquid B and the treatment agent A from being mixed with each other, and to prevent functions of the cleaning liquid B and the treatment agent A from being deteriorated.

According to the first embodiment, the drying unit 14 dries the head portion 3 after the treatment agent A is supplied. Therefore, even if the head portion 3 comes into contact with a skin surface, a user does not feel wet or cold by the cleaning liquid B. Thus, a user who does not like to feel wet or cold does not feel uncomfortable.

According to the first embodiment, the filter unit 18 and the agent container 28 constitute the cartridge 33 and thus, the filter unit 18 and the agent container 28 can be exchanged at the same time with one exchanging operation and the labor for the exchanging operation can be reduced. The cost can be lowered as compared with a case that the filter unit 18 and the agent container 28 are independent from each other.

According to the first embodiment, because the treatment agent A is supplied to the head portion 3 located at the lower end of the hair processing device 2 supported by the supporting unit 11, the treatment agent A does not drop onto other portion (grip 4) of the hair processing device 2 other than the head portion 3. Thus, the treatment agent A does not adhere to a hand of a user who grips the other portion (grip 4) of the hair processing device 2 other than the head portion 3, and the user does not feel uncomfortable.

Because the treatment agent A is supplied to the head portion 3 located at the lower end of the hair processing device 2 supported by the supporting unit 11, it is possible to prevent the treatment agent A from entering the head portion 3.

According to the first embodiment, because the treatment agent A is supplied to the hair processing device 2 from the agent supply device 1, it is unnecessary to provide the hair processing device 2 with a structure which stores the treatment agent A and with a structure which supplies the treatment agent A to the head portion 3. Therefore, the hair processing device 2 can be reduced in size correspondingly.

In the first embodiment, the treatment agent A is supplied to the blade 6 of the head portion 3 from the agent delivery port 32. Because the blade 6 is a portion which comes into contact directly with a skin surface, it is possible to easily apply the treatment agent A to the skin surface.

In a state where the hair processing device 2 is fixed to the supporting unit 11, the connection terminal provided on the bottom face of the hair processing device 2 and the connection terminal provided on the supporting unit 11 are connected to each other, electricity is supplied to the hair processing device 2 from the agent supply device 1 through the connection terminals, and the hair processing device 2 is charged with electricity. Because the hair processing device 2 is charged with electricity after the hair processing device 2 is cleaned and a treatment agent is supplied, it is possible to prevent the battery from being exhausted during shaving and the usability is excellent.

### Second Embodiment

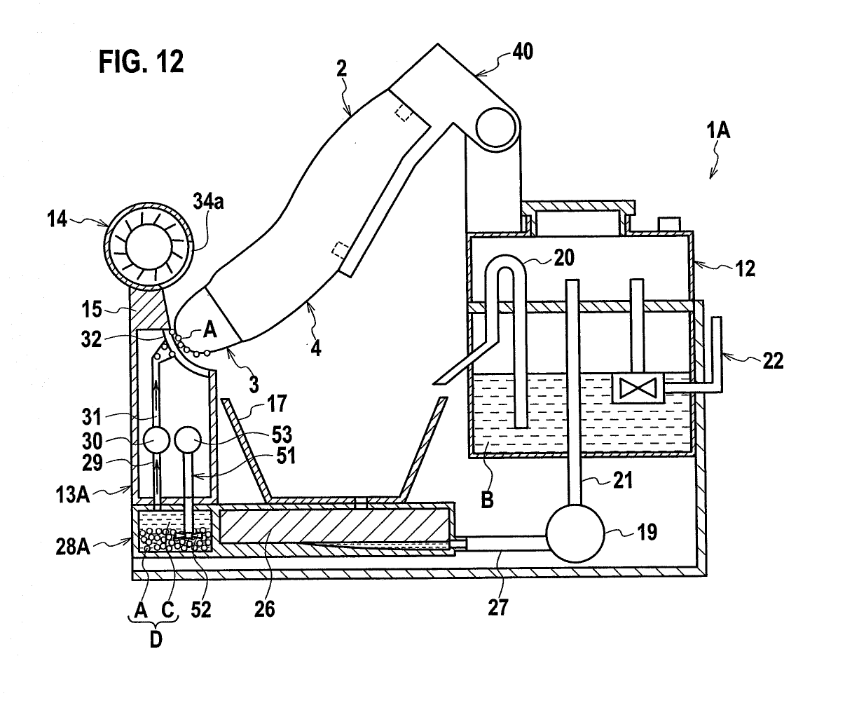

A second embodiment of the present invention will be explained next with reference to FIG. 12. Note that constituent elements that are the same as those explained in the first embodiment are denoted by like reference numerals, and explanations thereof will be omitted (this also applies to third and fourth embodiments). FIG. 12 is a vertical sectional view of a agent supply device 1A according to the second embodiment along with the hair processing device 2.

In the second embodiment, liquid mixture D of the powdery treatment agent A and liquid C such as water is stored in a agent container 28A, and the agent supplying unit discharges (sprays) the treatment agent A and the liquid C.

A agent supplying unit 13A is provided with a stirring unit 51. The stirring unit 51 includes a material to-be-stirred 52 which is turnably provided in the agent container 28A, and a motor 53 that turns and drives the material to-be-stirred 52. The motor 53 turns the material to-be-stirred 52, and the stirring unit 51 stirs the liquid mixture D in the agent supplying unit 13A. The stirring action is carried out before and while the treatment agent A is supplied to the head portion 3 from the agent supplying unit 13A.

With this structure, the powdery treatment agent A and the liquid C are discharged and they are supplied to the head portion 3, and the powdery treatment agent A can reliably adhere to the head portion 3 by the liquid C. With this, high skin slip effect by the powdery treatment agent A can be obtained. With this, it is possible to reliably avoid a case that the treatment agent A overflows from the head portion 3 or the treatment agent A hits the head portion 3 and scatters.

According to the second embodiment, the liquid mixture D in the agent supplying unit 13A is stirred by the stirring unit 51 and thus, the mixed state of the liquid mixture D can be uniform, and the treatment agent A can adhere to the head portion 3 uniformly. Even if the treatment agent A has large diameter which enhances the skin slip, the treatment agent A can be stirred uniformly by the rotation of the material to-be-stirred 52.

### Third Embodiment

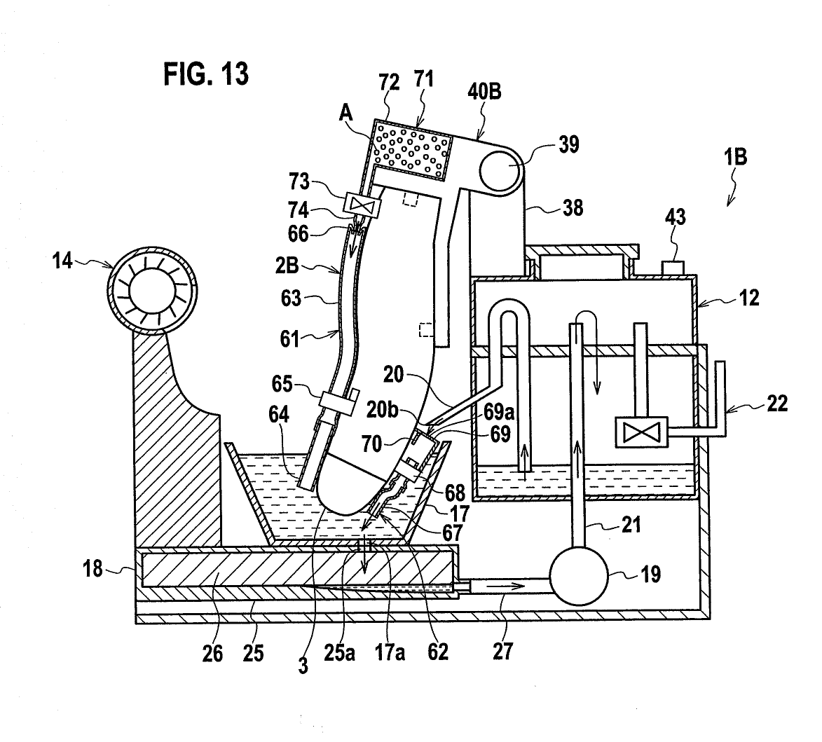

A third embodiment of the present invention will be explained next with reference to FIG. 13. FIG. 13 is a vertical sectional view of a agent supply device 1B and a hair processing device 2B according to the third embodiment.

In the third embodiment, the hair processing device 2B is provided with a skin surface agent supplying unit 61 that supplies a treatment agent A to a skin surface, and a agent collecting unit 62 that collects the treatment agent A on a skin surface. The agent supply device 1B cleans the agent collecting unit 62 and supplies the treatment agent A to the skin surface agent supplying unit 61.

The head portion 3 is provided between skin surface agent supplying unit 61 and the agent collecting unit 62 of the hair processing device 2B. The skin surface agent supplying unit 61 includes a agent container 63 in which a treatment agent A is stored, a agent delivery port 64 that is connected to the agent container 63 and that discharges the treatment agent A, and a discharge pump 65 that supplies the treatment agent A in the agent container 63 to the agent delivery port 64. If the discharge pump 65 is driven, the treatment agent A in the agent container 63 is discharged from the agent delivery port 64. The agent container 63 is provided at its bottom with a check valve 66, and the check valve 66 is closed at a normal time.

The agent collecting unit 62 includes a suction port 67 that sucks the treatment agent A, a suction pump 68 whose suction side is connected to the suction port 67, and a agent collecting container 69 connected to a discharge side of the suction pump 68. If the suction pump 68 is driven, the treatment agent A on the skin surface is sucked from the suction port 67, and the sucked treatment agent A is collected in the agent collecting container 69. In the bottom of the agent collecting container 69A, through hole 69a is formed, and a lid 70 that opens and closes the through hole 69a is turnably provided. The lid 70 is turned by its own weight to open and close the through hole 69a.

The agent supply device 1B will be explained. The supporting unit 11B has an arm portion 40B. The arm portion 40B is provided with a agent supplying unit 71 that supplies a treatment agent A to a skin surface agent supplying unit 61 of the hair processing device 2B. The agent supplying unit 71 includes a agent container 72 in which the treatment agent A is stored, a pump 73 whose suction side is connected to an interior of the agent container 72, and a agent delivery port 74 connected to a discharge side of the pump 73. The agent container 72 is detachably attached to the arm portion 40B. The agent delivery port 74 is inserted into a check valve 66 of the agent container 63 of the hair processing device 2B, thereby opening the check valve 66.

The delivery port 20b of the discharge pipe 20 of the agent supply device 1B is located above the through hole 69a formed in the bottom of the agent collecting container 69 of the hair processing device 2B located at the cleaning position, and the delivery port 20b discharges the cleaning liquid B into the through hole 69a.

In such a structure, according to the third embodiment, the cleaning unit 12 and the agent supplying unit 71 are driven with one set. More specifically, in a state where the agent delivery port 74 is inserted into the check valve 66 of the agent container 63 of the hair processing device 2B and the hair processing device 2B is located at the cleaning position, the cleaning operation of the head portion 3 is carried out. At that time, the cleaning liquid B is discharged from the delivery port 20b of the discharge pipe 20 into the through hole 69a formed in the bottom of the agent collecting container 69 of the hair processing device 2B. The cleaning liquid B passes through the agent collecting unit 62 of the hair processing device 2B and is discharged into the cleaning pan 17 from the suction port 67. With this, the cleaning operation of the agent collecting unit 62 of the hair processing device 2B is carried out by the cleaning liquid B.

A pump 73 of the agent supplying unit 71 is driven at the time of the cleaning operation, and the treatment agent A in the agent container 72 is supplied from the agent delivery port 74 into the agent container 63 of the hair processing device 2B. With the above operation, the function of the control unit that drives the cleaning unit 12 and the agent supplying unit 71 with one set is executed.

As explained above, in the third embodiment, the cleaning unit 12 and the agent supplying unit 71 are driven with one set. Thus, if the driving operation is completed, dust is removed from the head portion 3 of the hair processing device 2B and the head portion 3 is clean, and the treatment agent A is supplied to the skin surface agent supplying unit 61. Therefore, when the hair processing device 2B is used, the treatment agent A can be supplied to the clean head portion 3 from the skin surface agent supplying unit 61 and the hair removing processing can be carried out. Thus, in the hair removing processing, dust such as flocking remaining on the head portion 3 does not adhere to a skin surface, so that the user does not feel uncomfortable.

According to the third embodiment, the cleaning unit 12 cleans the agent collecting unit 62 of the hair processing device 2B and the agent collecting unit 62 can be cleaned.

### Fourth Embodiment

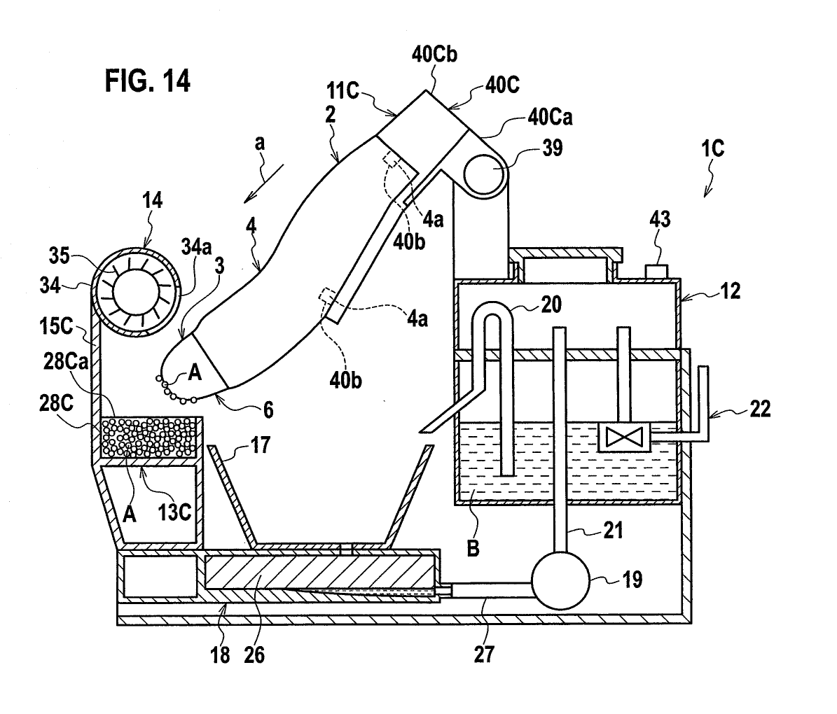

A fourth embodiment of the present invention will be explained next with reference to FIG. 14. FIG. 14 is a vertical sectional view of a agent supply device 1C according to the fourth embodiment and the hair processing device 2. FIG. 14 shows a state where the treatment agent A is supplied to the head portion 3.

The agent supply device 1C according to the fourth embodiment is different from the first embodiment in that the agent supply device 1C has a agent supplying unit 13C. The agent supplying unit 13C according to the fourth embodiment does not have the pump 30 that discharges the treatment agent A. Instead of this, a agent container 28C that stores the treatment agent A is provided at its upper face with an opening 28Ca. The head portion 3 of the hair processing device 2 is directly inserted into the agent container 28C from the opening 28Ca, and the treatment agent A can be supplied to the head portion 3. Liquid mixture D can be stored in the agent container 28C.

The head portion 3 of the hair processing device 2 located at a set position by a supporting unit 11C is opposed to the opening 28Ca of the agent container 28C.

The supporting unit 11C has an arm portion 40C. The arm portion 40C includes a base portion 40Ca connected to the shaft 39, and a slide body 40Cb that is slidably provided on the base portion 40Ca by a slide mechanism (not shown) and that holds the hair processing device 2. The slide body 40Cb can slide between a first position where the head portion 3 is located at a set position, and a second position where the head portion 3 enters the agent container 28C. The slide body 40Cb is locked at the first position by a lock mechanism (not shown). The lock mechanism is a lock structure for example, and if a determined or higher force is applied so that the slide body 40Cb is moved from the first position to the second position, the locked state is unlocked.

In the fourth embodiment, the drying unit 14 is driven when a drying switch (not shown) is turned ON.

In this structure, after the cleaning operation of the head portion 3 of the hair processing device 2 by the cleaning unit 12 is completed, the treatment agent A can be supplied to the head portion 3 of the hair processing device 2 that is returned to the set position. That is, after the head portion 3 is cleaned, a user slides the hair processing device 2 supported by the slide body 40Cb from the set position toward the agent container 28C, brings the head portion 3 into the agent container 28C, and the treatment agent A in the agent container 28C adheres to the head portion 3. At that time, because the head portion 3 has been cleaned, the treatment agent A is supplied to the clean head portion 3 from which dust such as remaining flocking is removed and thus, dust such as flocking remaining on the head portion 3 does not adhere to a skin surface in the hair removing processing. Thus, in the hair removing processing, dust such as flocking remaining on the head portion 3 does not adhere to a skin surface, so that the user does not feel uncomfortable.

If the user turns the drying switch ON, the drying unit 14 can dry the head portion 3.

The agent supply device 1C does not use a pump that supplies the treatment agent A to the head portion 3. Therefore, the structure can be simplified, and the device of the fourth embodiment can be reduced in size and cost as compared with that of the first embodiment.

The present invention is not limited to the above embodiments, and various other embodiments can be employed without departing from the scope of the invention.

For example, although the pump 19 is used for supplying the treatment agent A in the above embodiments, the head portion 3 of the hair processing device 2 can directly abut against, the treatment agent A in the agent container 28 without providing the pump 19.

Further, the treatment agent A and the liquid C can be stored separately in different tanks, and the liquid C can be atomized and discharged to the head portion 3.

1. A agent supply device comprising
a cleaning unit that cleans a head portion provided on a hair processing device that removes hair,
a agent supplying unit that supplies a treatment agent used when removing hair to the head portion, and
a control unit that drives the agent supplying unit after a cleaning operation of the head portion by the cleaning unit is completed.

2. The agent supply device according to claim 1, wherein the cleaning unit cleans the head portion using cleaning liquid,
the treatment agent is powdery, and
the control unit allows the agent supplying unit to supply the treatment agent to the head portion in a state where the head portion is cleaned by the cleaning unit and the cleaning liquid adheres to the head portion.

3. The agent supply device according to claim 1, wherein the treatment agent is powdery, and
the agent supplying unit discharges the treatment agent together with liquid and supplies them to the head portion.

4. The agent supply device according to claim 1, further comprising a supporting unit that moves the head portion selectively to a cleaning position where the head portion is cleaned by the cleaning unit and a supply position where the treatment agent is supplied by the agent supplying unit, wherein
the control unit drives the supporting unit such that the head portion is located at the cleaning position when the head portion is cleaned by the cleaning unit, and the head portion is located at the supply position when the treatment agent is supplied by the agent supplying unit.

5. The agent supply device according to claim 2, further comprising a drying unit that dries the head portion, wherein
the control unit drives the drying unit after the agent supplying unit supplies the treatment agent to the head portion.

6. The agent supply device according claim 1, wherein the cleaning unit includes a filter unit that filters the cleaning liquid, the agent supplying unit includes a agent container in which the treatment agent is stored, the filter unit and the agent container are integrally formed together to constitute a cartridge, and
the agent supply device further comprises a cartridge supporting unit that detachably supports the cartridge.

7. A agent supply device comprising
a cleaning unit that cleans a head portion of a hair processing device including the head portion that removes hair and a skin surface agent supplying unit that supplies a treatment agent used when removing hair to a skin surface,
a agent supplying unit that supplies the treatment agent to the skin surface agent supplying unit, and
a control unit that drives the cleaning unit and the agent supplying unit with one set.

8. The agent supply device according to claim 1, wherein the hair processing device includes a agent collecting unit that collects the treatment agent on a skin surface and the cleaning unit cleans the agent collecting unit.

9. The agent supply device according to claim 1, further comprising a supporting unit that supports the hair processing device such that the head portion becomes a lower end of the hair processing device when the agent supplying unit supplies the treatment agent.

10. A agent supply device comprising a cleaning unit that cleans a head portion provided on a hair processing device that removes hair, and
a agent supplying unit that can supply a treatment agent used when removing hair to the head portion after a cleaning operation of the head portion by the cleaning unit is completed.

11. The agent supply device according to claim 3, further comprising a drying unit that dries the head portion, wherein
the control unit drives the drying unit after the agent supplying unit supplies the treatment agent to the head portion.

12. The agent supply device according to claim 7, wherein the hair processing device includes a agent collecting unit that collects the treatment agent on a skin surface and the cleaning unit cleans the agent collecting unit.

13. The agent supply device according to claim 7, further comprising a supporting unit that supports the hair processing device such that the head portion becomes a lower end of the hair processing device when the agent supplying unit supplies the treatment agent.
